(19) United States
(12) Patent Application Publication
(10) Pub. No.: US 2009/0214937 A1
(43) Pub. Date: Aug. 27, 2009

(54) VEHICLE BATTERY ARRANGEMENT COMPRISING ELECTRONIC COMPONENTS

(75) Inventors: Günther Bauer, Ottobrunn (DE); Winfried Rickert, Feldkirchen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: IQ POWER LICENSING AG, 6304 Zug (CH)

(21) Appl. No.: 11/571,752

(22) PCT Filed: Jul. 7, 2005
(86) PCT No.: PCT/DE2005/001191

§ 371 Date: Oct. 27, 2008

(30) Foreign Application Priority Data
Jul. 7, 2004 (DE) 10 2004 032 947.8

(51) Int. Cl. H01M 10/02

(52) U.S. Cl. 429/92

(57) ABSTRACT

The invention relates to a vehicle battery arrangement comprising sensors and an electronic sensor system, by which means the charging and operating state of the vehicle battery is monitored. Said vehicle battery arrangement comprises a heat insulating box (1) provided with a cover (9). The sensors, electronic sensor system and other electronic components for data processing and storage are split between two thermally coupled electronic modules. A first electronic module is connected to the battery in a mechanically fixed manner as a battery module (6), and the second electronic module is connected to the cover (9) of the heat insulating box (1) in a mechanically fixed manner as a cover module (12), the two modules being interconnected for data transmission preferably by means of a power line communication.

The invention relates to a vehicle battery arrangement comprising sensors and an electronic sensor system, by which means the charging and operating state of the vehicle battery is monitored.

Batteries having such arrangements are known from prior art. As the quantities to be measured are also superimposed by disturbances which adulterate the measured values, the sensors and the electronic sensor system have to be configured so that the adulterated measured values, i.e. measurement errors are kept less than a predetermined level. Especially, as the electronic sensor system is concerned, several methods for correcting measurement errors are known from prior art.

For example, DE 100 56 972 A1 discloses a device for monitoring the operating state of a battery, which is arranged in the battery to make the electrical connections between the components as short as possible. This device includes a temperature sensor for detecting the internal temperature of the battery and a density sensor for detecting the electrolyte density, which are arranged in a cell of the battery. The appertaining electronic components are arranged directly above the battery cells and inside the battery box, respectively. Such a device for monitoring the operating state of a battery is disadvantageous in that the relatively expensive structural elements thereof will remain in the battery when it is scrapped, and therefore, the total price of a battery becomes unacceptably high.

Therefore, object of the invention is to provide a vehicle battery arrangement having a device for monitoring the operating state of the battery, which allows the sensor data to be detected and evaluated exactly and can be manufactured cost-effectively.

This object of the invention is accomplished by a vehicle battery arrangement defined in claim 1.

The vehicle battery arrangement according to the invention comprises a vehicle battery which is housed in a heat-insulating box. The heat-insulating box is provided with a removable cover. Furthermore, a device for monitoring the operating state of a battery is provided, which comprises many electronic elements and components, i.e. at least one sensor for detecting at least one of the measured value specific to a battery, such as battery voltage, battery current, battery temperature and electrolyte density. In addition, circuits for transforming the measuring signals and circuits for carrying out storing and calculating procedures are provided.

The electronic elements and components are split into two modules spatially separated from each other, wherein splitting is done according to the following principle:

Those electronic elements and components which functionally belong to the battery box may only be arranged in or on the battery, i.e. in the battery module.

When, for example, the principle of measurement presupposes immersing, it is always necessary to use a sensor immersed into the electrolyte to measure the density thereof. When measurement data concerning the inside of a battery are to be stored temporarily and remained at least partly with the battery, it is always necessary to provide the battery with a memory element, into which the sensor data and the code number are stored and which remains with the battery.

The residual electronic elements and components are combined to a cover module which is arranged on the inside surface of the cover closing the heat-insulating box, wherein the battery module and the cover module are arranged close to each other to shorten the connecting wires between them.

Compared to the prior art, this invention is advantageous in that the connecting wires between the components can also be held short and only those electronic elements and components combined in the battery module be lost when the battery is scrapped. Those electronic elements and components combined in the cover module remain on the cover of the heat-insulating box, which is part of the vehicle and will not be removed when the battery is scrapped. This means remarkably lower cost compared to the prior art.

A further advantage unknown up to now is that almost no temperature gradients caused from outside can occur in the interior of the battery, as variations in the ambient temperature penetrate the heat-insulating box and enter the battery very slowly, only. Positive effects resulting from it will be described below.

Almost ever, the sensors show temperature-dependent characteristics so that variations in temperature will adulterate the measured values. The electronic gain circuits, which are arranged immediately behind the sensor, also show temperature-dependent characteristics. For this reason, specific circuits for temperature compensation were developed several decades ago, wherein temperature compensation is mainly understood to be a static compensation, i.e. a compensation when the ambient temperature of sensors or evaluation electronics has a predetermined value which does not change or changes very slowly, only. In other words, temperature compensation is optimal, when no temperature balancing takes place, i.e. no temperature gradients occur within the range of sensors and/or the evaluation electronics, preferably in the first portion thereof.

It is relatively difficult to cope with measurement errors which occur when temperature balancing procedures take place. For example, the temperature around the sensor or the evaluation electronics can differ from that at the actual point of measurement, which is intended to be used as a correction value for temperature compensation. Therefore, in this case, the temperature compensation of the measured value is very incorrect in part.

As the heat-insulating box prevents non-admissibly great temperature gradients from occurring inside the battery, the actual measurement value can be exactly determined and/or it is not necessary to set high requirements on the evaluation electronics with respect to the temperature sensitivity thereof. In turn, this is advantageous in that the electronics can be manufactured cost-effective, that is especially required when products such as vehicle batteries are made in very great amounts.

The temperature effects adulterating the measured values, which are described above, relate to a physical parameter other than the temperature, but experts in the field of measuring technology certainly know that temperature-dependent errors can also occur when temperature measurements are carried out, i.e. when a spatial and a temporal temperature gradient is present between the temperature sensor and the evaluation electronics.

According to claim 2, a vehicle battery is provided with a device for intermixing the liquid electrolyte to gain a faster temperature balancing in the heat-insulating box. This further development of the invention is especially advantageous when a vehicle battery is provided with heating means known from prior art.

Such heating means are used to heat the liquid electrolyte. Conventionally, a resistance heating element is fixed to the battery box, for example, in order to heat the battery at low outside temperatures, such as that in winter time, so that its capability for receiving and supplying current is remarkably improved. However, as mentioned above, such heating means generate non-wanted temperature gradients in the battery case, which can interfere sensitive measurements of battery values. When the liquid electrolyte is thoroughly mixed, the temperature thereof is effectively distributed and non-wanted temperature gradients caused by heating are minimized. In other words, the further development of the invention is advantageous in that a faster temperature balance is gained, in addition to the intermixing of the electrolyte.

According to claim 3, the device for intermixing the liquid electrolyte utilizes the movements of a vehicle to circulate the liquid electrolyte inside the battery box. Such devices are conventionally known and are configured so that the electrolyte is caused to flow along a predetermined path and thereby, is mixed thoroughly. The further development of the invention is advantageous in that the mixing device is simply configured and low in price and allows self-acting intermixing of the electrolyte.

According to claim 4, the cover is provided with electric contacts which match to that of the vehicle battery and are accessible at the outside surface of cover, wherein the electric contacts are configured so that a mechanically and electrically stable and properly dimensioned connection is formed when the cover is put onto the heat-insulating box. This embodiment is especially advantageous in that an additional expensive holder is not required for the cover and therefore, the total cost can be reduced.

According to claim 5, the battery module is connected to the cover module via a power-line data communication which is routed through the electric contacts of the battery. The best embodiment of this invention allows an additional wiring between the cover module and the battery module to be dispensed with.

Now, the invention will be described in detail by means of a practical example in conjunction with the accompanying schematic drawings.

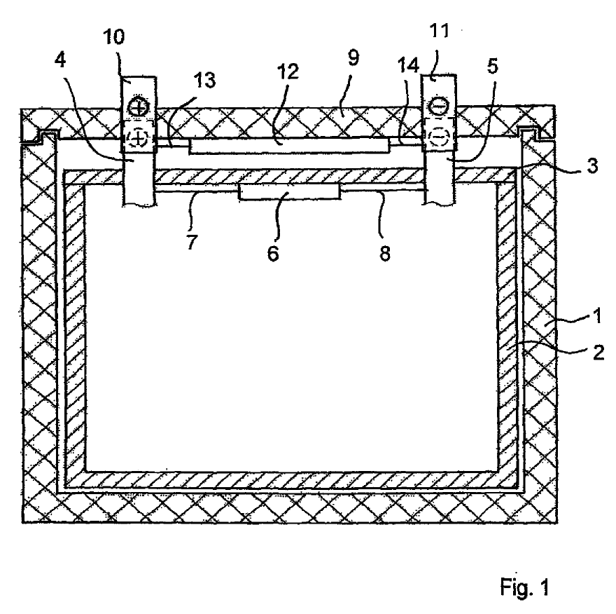

FIG. 1 shows schematically a cross-sectional view of the invention.

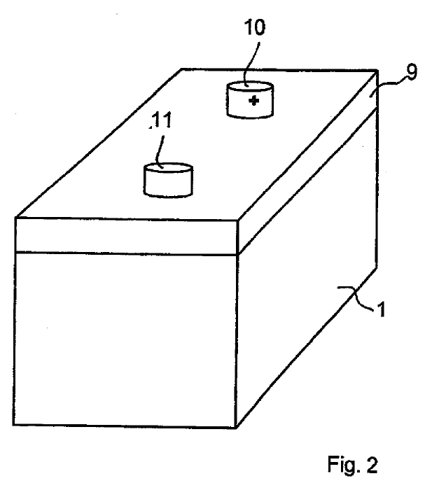

FIG. 2 shows a perspective graph of the general view.

In FIG. 1, reference numeral 1 denotes a heat-insulating box which is made of a foamed plastic material having a high heat-insulating capacity. A lead-acid battery, which is composed of a case 2, a cover 3 and two electric contacts 4 and 5, is placed in the heat-insulating box 1. A resistance heater (not shown) for heating the battery is arranged on an outside surface of the case 2. Mixing means (not shown) are arranged in the case 2, which cause the acid in the battery to be mixed thoroughly by forces generated when the vehicle is accelerated and decelerated.

The battery module 6, which comprises a temperature sensor, first evaluation electronics and at least one data memory for storing at least the code number and one set of sensor data of the battery, is arranged on the bottom surface of cover 3. The code number identifies the battery and the set of sensor data includes data on the operating state of the battery, wherein the operating state is understood to be a quantity characterizing the state of charge and the state of wear of the battery. The battery module 6 is energized by the battery with a voltage supplied via the lines 7 and 8.

The heat-insulating box 1 is closed by a cover 9 comprising electric contacts 10 and 11, which match to the electric contacts 4 and 5 and are engaged with those so that a sufficiently reliable mechanical and electrical connection is formed. The cover module 12 arranged on the bottom surface of cover 9 is also energized by the battery with a voltage supplied via the lines 12 and 14.

Data transfer between the battery module 6 and the cover module 12 takes place via a power-line communication such as a CAN bus.

It is very important to mention, that the set of sensor data, which represents the actual and the preceding operating state of the battery, must not necessarily be measured and calculated by the battery module alone, but can be obtained by the cover module or an other external module, e.g. the vehicle's own computer, and sent back to the battery module via the power-line.

1. Vehicle battery arrangement including a vehicle battery provided with electric contacts and a device for monitoring the operating state of battery, wherein
the vehicle battery
is housed in a heat-insulating box having a cover and
the device for monitoring the operating state of the battery comprises at least
a sensor,
a signal conversion circuit,
a first signal processing circuit and
at least another signal processing circuit, wherein
at least one electronic data memory is arranged in the first signal processing circuit and wherein
the first signal processing circuit is combined to a battery module non-detachably mounted to an inside surface or an outside surface of the battery case and
the second signal processing circuit is combined to a cover module arranged on the cover (9) of the heat-insulating box (1).

2. Vehicle battery arrangement according to claim 1, characterized in that the vehicle battery is a liquid electrolyte type battery provided in the inside thereof with a device for intermixing the liquid electrolyte.

3. Vehicle battery arrangement according to claim 2, characterized in that the device for intermixing the liquid electrolyte works on the principle of electrolyte movement occurring when the vehicle is accelerated.

4. Vehicle battery arrangement according to claim 1, characterized in that the cover is provided with electric contacts which match to the electric contacts of the vehicle battery and are accessible at the outside of the cover and are configured so that a sufficiently dimensioned mechanical and electrical connection is formed when the cover is placed onto the heat-insulating box.

5. Vehicle battery arrangement according to claim 4, characterized in that the battery module and the cover module are interconnected via a power-line data communication which is routed via the electric contacts.

6. A battery arrangement for a vehicle, comprising:
an open-topped heat-insulating box;
a vehicle battery having a battery case and received in the heat-insulating box, and;
a cover for closing the heat-insulating box; and
a device for monitoring an operating state of the battery, said device comprising
a battery module non-detachably mounted to the battery case of the battery and including
a sensor for ascertaining a state variable of the vehicle battery,
an electronic data memory for storing the state variable, and
a cover module arranged on the cover in close proximity of the battery module.

7. The battery arrangement of claim 6, wherein the vehicle battery is a liquid electrolyte type battery and including a device placed inside the vehicle battery for intermixing the liquid electrolyte.

8. The battery arrangement of claim 7, wherein the device for intermixing the liquid electrolyte works on the principle of electrolyte movement occurring when the vehicle is accelerated.

9. The vehicle battery arrangement of claim 6, wherein the vehicle battery is provided with first electric contacts, and the cover is provided with second electric contacts which complement the first electric contacts of the vehicle battery, said second electric contacts being accessible from outside the cover and configured to form with the first electric contact a mechanical and electrical connection, when the cover is placed onto the heat-insulating box.

10. The vehicle battery arrangement of claim 9, further comprising a power-line data communication for interconnecting the battery module and the cover module, said power-line data communication being routed via the first and second electric contacts.
